(19) United States
(12) Patent Application Publication
(10) Pub. No.: US 2026/0236713 A1
(43) Pub. Date: Aug. 13, 2026

(54) MODEL-AGNOSTIC GENERATION OF REFINED PROMPTS BASED ON PRE-PROCESSED TASK DESCRIPTIONS AND EXPECTED OUTPUT STRUCTURES

(71) Applicant: Bold Limited, Hamilton (BM)

(72) Inventors: Durgesh GUPTA, Greater Noida West (IN); Nilesh Kumar SRIVASTAVA, Greater Noida (IN); Shailesh KRISHNA, Ghaziabad (IN); Mohit Kumar GOEL, Greater Noida (IN)

(21) Appl. No.: 19/051,586

(22) Filed: Feb. 12, 2025

(51) Int. Cl. G06F 40/40

(52) U.S. Cl. CPC G06F 40/40

(57) ABSTRACT

Certain aspects of the disclosure provide a method for generating modified prompts. In aspects, the method includes receiving input; generating, using a context processing component, a first prompt by incorporating the input into a prompt template corresponding to an input type associated with the input, wherein the first prompt is configured to cause a language model to generate a pre-processed task description associated with the input; providing the first prompt to a language model for generating the pre-processed task description associated with the input; receiving the pre-processed task description from the language model; generating a second prompt by incorporating the pre-processed task description and the input into a second prompt template, wherein the second prompt is configured to cause the language model to generate a modified prompt; providing the second prompt to the language model; and returning the modified prompt to the user.

### INTRODUCTION

### Technical Field

Aspects of the present disclosure relate to methods for generating modified prompts for generative artificial intelligence (AI) models based on pre-processed task descriptions and expected output structures.

### Background

Organizations are increasingly incorporating generative AI models, such as language models, into products and services involving generation of human-like text. For example, language models can support improvements in chatbots, content creation, question-response services, and more. Language models generate outputs based on an input prompt. The prompt provides context or instructions for guiding the language model to generate outputs for a given task. Thus, improved techniques related to generating modified prompts for efficient prompt refinement are desirable for promoting the implementation of prompts having increased quality and effectiveness for increasing the quality of generated language model outputs.

### SUMMARY

Certain aspects provide a method for generating modified prompts, the method including: receiving input comprising one of a target prompt or a preliminary task description from a user; generating, using a context processing component, a first prompt by incorporating the input into a prompt template corresponding to an input type associated with the input, wherein the first prompt is configured to cause a language model to generate a pre-processed task description associated with the input; providing the first prompt to a language model for generating the pre-processed task description associated with the input; receiving the pre-processed task description from the language model; generating a second prompt by incorporating the pre-processed task description and the input into a second prompt template, wherein the second prompt is configured to cause the language model to generate a modified prompt based on the pre-processed task description and the input; providing the second prompt to the language model for generating the modified prompt; receiving the modified prompt from the language model; and returning the modified prompt to the user

Other aspects provide processing systems configured to perform the aforementioned method as well as those described herein; non-transitory, computer-readable media comprising instructions that, when executed by a processors of a processing system, cause the processing system to perform the aforementioned method as well as those described herein; a computer program product embodied on a computer readable storage medium comprising code for performing the aforementioned method as well as those further described herein; and a processing system comprising means for performing the aforementioned method as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an illustrative environment for implementing a refined prompt generation system according to one or more aspects.

FIG. 2 depicts an example process implementable by a refined prompt generation system for generating modified prompts according to one or more aspects.

FIG. 3 depicts an example process implementable by a refined prompt generation system for generating modified prompts based on an input target prompt according to one or more aspects.

FIG. 4 depicts an example process implementable by a refined prompt generation system for generating modified prompts based on an input preliminary task description according to one or more aspects.

FIG. 5 depicts an example process implementable by a refined prompt generation system for generating modified prompts compatible with an employed language model according to one or more aspects.

FIG. 6 depicts an example method for generating modified prompts implementable by a refined prompt generation system according to one or more aspects.

FIG. 7 depicts an example processing system for enabling a refined prompt generation system for generating modified prompts according to one or more aspects.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for generating modified prompts for generative AI models based on pre-processed task descriptions and expected output structures. Refined prompt generation systems in accordance with described aspects include a context processing component configured to generate a first prompt for causing a language model to generate a pre-processed task description for a received target prompt or preliminary task description. As used herein a “pre-processed task description” (PPTD) refers to a set of refined instructions for magnifying structural and contextual features of a prompt by focusing the set of refined instructions on at least objectives, steps for achieving the objectives, and expected outputs for a target prompt being modified. The pre-processed task descriptions generated based on the generated first prompt are then passed to an adaptive prompt generating component configured to generate a second prompt for causing a language model to generate a modified prompt based on the generated PPTD. By incorporating the generated PPTD, the second prompt ensures that the modified prompt generated by the language model includes instructions for enabling generation of clear and precise outputs that are improved by considering expected output structures and rich contextual information. In some examples, a refined prompt generation system may further generate modified prompts having improved compatibility with a specific language model type corresponding to a language model being employed. For example, an input target prompt compatible with a first language model of a first type may be used by a refined prompt generation system to generate a modified prompt compatible with a second language model of a second type. For example, compatibility of a prompt with a specific language model type may be measured by comparing test outputs of the prompt across models.

Conventional techniques for generating modified prompts, such as for prompt refinement, often involve prompt engineers iteratively and manually editing prompt instructions. The prompt engineers then experiment with different versions of a prompt to determine what produces the most relevant outputs. Manual prompt refinement by prompt engineers is costly and prone to human-error while lacking in scalability due to the limited speed at which a prompt engineer can rewrite and evaluate prompts.

Other conventional techniques for generating modified prompts utilize predefined templates and guidelines, such as stored within developed libraries, to streamline prompt creation and reduce variability in output quality. However, utilizing predefined templates and guidelines creates prompts that are often too generic, off-topic, or even misleading with respect to a given task or objective, thereby minimizing specificity and focus of prompt instructions. For example, a prompt generated using a pre-defined template may lack specificity with respect to expected output structures and other prompt-specific contextual information such as specific steps for achieving an objective or challenges related to techniques being employed. Thus, prompts generated using predefined templates and guidelines can cause language models to generate lower quality outputs that are less precise due to leveraging less contextual information.

Yet other conventional approaches for generating modified prompts utilize machine learning or rule-based systems to iteratively improve prompts based on evaluation of generated outputs. However, machine learning and rule-based systems employ a reactive approach for generating modified prompts that is only implemented after quality of generated outputs has been negatively impacted, thereby worsening user experiences and reducing efficiency in prompt evaluation and refinement due to the additional computation resources and time required for performing reactive iterations. In addition, machine learning and rule-based systems are often refined for generating specific prompt types, linguistic patterns, keywords, or formatting preferences that align with a language model of a specific type, thereby reducing the portability of these systems across different language model types. In such cases, prompts often need to be rewritten when switching between different language models because each language model has unique architecture, training data, and processing capabilities, leading to varied responses to the same prompt across different models.

Aspects described herein provide a technical solution for the aforementioned technical problems by providing systems and methods for generating modified prompts based on pre-processed task descriptions and expected output structures. In particular, refined prompt generation systems described herein include a context processing component configured to generate a first prompt for causing a language model to generate a PPTD based on a target prompt and a corresponding expected output structure. The PPTD and expected output structure are then incorporated into a second prompt for causing the language model to generate a modified prompt based on structural and contextual features within the generated PPTD. For example, the PPTD may include objectives, steps for achieving the objectives, expected outputs, and anticipated challenges associated with the target prompt. By incorporating the PPTD and expected output structures into the generated second prompt, described aspects cause language models to generate modified prompts of increased quality. For example, the generated modified prompts account for the additionally provided structural and contextual information, thereby overcoming the lack of context provided by conventional techniques for generating modified prompts that rely on predefined templates or guidance. The context provided by the PPTD and expected output structures in the second prompt further enable refined prompt generation systems to proactively identify potential challenges for preemptively incorporating into generated modified prompts, causing an increase in the quality of generated outputs. Accordingly, the refined prompt generation systems described herein overcome the shortcomings of conventional machine learning and rule-based systems that employ reactive approaches that only implement modifications to prompts after the quality of generated outputs has been negatively impacted.

In some aspects, refined prompt generation systems are further implementable using a fully automated system that provides for increased scalability and cost-effectiveness while overcoming the shortcomings of conventional techniques for generating modified prompts that rely on costly and manual prompt refinement by prompt engineers. Further, refined prompt generation systems described herein are configured to generate modified prompts for a target prompt that have increased compatibility with an employed language model type regardless of the compatibility of the target prompt with the employed language model type. For example, a target prompt that is compatible with a language model “A” of a first language model type, may be input and processed by refined prompt generation systems to return a modified prompt that is compatible with a second language model type based on an employed language model “B” of the second language model type. In some examples, described aspects generate prompts that may be processed by an employed language model of a given language model type to generate a modified prompt having increased compatibility with the employed language model type. Accordingly, refined prompt generation systems described herein demonstrate model agnosticism, being able to employ language models of different language model types to perform techniques described herein to generate a modified prompt having increased compatibility with the language model type of the employed language model. Thus, refined prompt generation systems described herein provide increased portability and overcome the lack of flexibility of conventional techniques for generating modified prompts that utilize machine learning and rule-based systems having model-specific limitations that reduce portability.

The refined prompt generation systems described herein for generating modified prompts provide various technical benefits. As an example, refined prompt generation systems include adaptive prompt generating components that leverage a generated PPTD and expected output structure associated with a target prompt. By incorporating the PPTD and expected output structure, described aspects generate a second prompt configured to cause a language model to proactively identify anticipated challenges and edge cases when generating modified prompts. Proactively identifying anticipated challenges and edge cases improves precision and accuracy of the outputs generated by a language model processing the modified prompts generated in accordance with described aspects. Generating modified prompts including anticipated challenges further provides the technical benefit of reducing computational costs and time required as compared to conventional techniques for generating modified prompts that reactively perform iterative prompt refinement based on reacting to unanticipated low quality outputs. Described aspects further provide an automated framework for generating modified prompts, thereby providing the technical benefit of increased scalability for performing prompt refinement while reducing required costs and human capital as compared to conventional techniques employing prompt engineers. In certain examples, described aspects may be further useful for generating a modified prompt having improved compatibility with an employed language model type. For example, a target prompt designed for use with a language model of a first type may be input into a refined prompt generation system in accordance with described aspects to generate a modified prompt (using a described context processing component and a described adaptive prompt generating component) having increased compatibility with an employed language model of a specific second type. By generating specially designed prompts that focus on leveraging task descriptions and expected output structures derived from a target prompt, refined prompt generation systems in accordance with described aspects may employ different language models of different language model types to consistently and effectively generate modified prompts having increased compatibility with the employed language model type. Thus, described aspects further provides the technical benefit of increased model agnosticism and portability as compared to conventional techniques for generating modified prompts that utilize machine learning and rule-based systems having model-specific limitations.

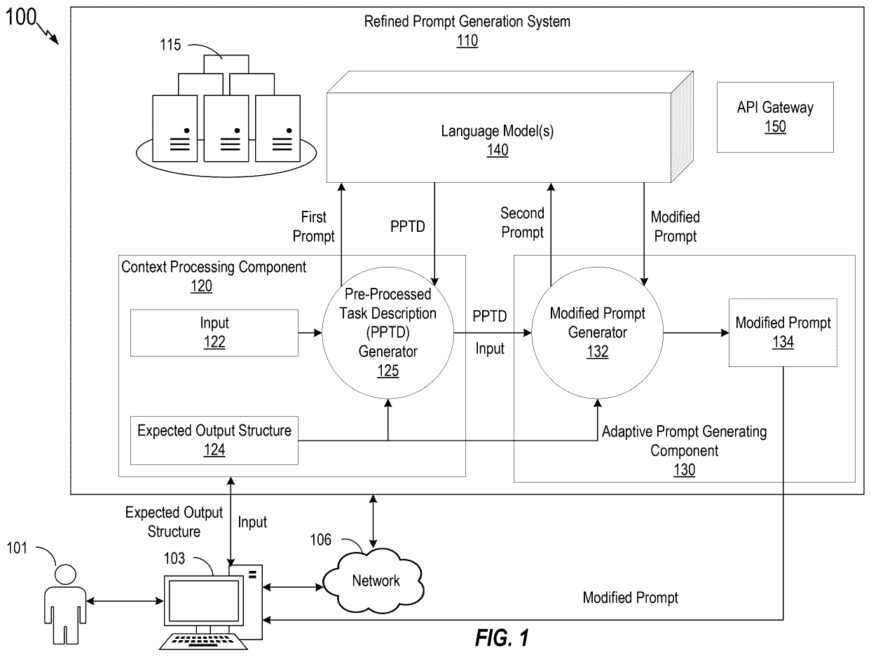

FIG. 1 depicts an illustrative environment 100 for implementing a refined prompt generation system 110 according to one or more aspects shown and described herein.

The refined prompt generation system 110 may be configured to interface with a user 101 seeking to obtain a modified prompt for refinement. Refined prompt generation system 110 may be employed as a standalone application (e.g. installed on a device) or may be employed by a local or web-based application or platform including multiple systems or tools therein. User 101 may interface with aspects of refined prompt generation system 110, for example implemented by one or more computing devices 115, using a device 103. In certain aspects, device 103 may be a personal computer, a tablet computer, a smart device (e.g., a smartphone), or the like.

In certain aspects, device 103 includes a display device for implementing a user interface with the respective user 101, one or more processors for executing logic and one or more non-transitory computer-readable mediums for storing information and/or computer readable instructions. In certain aspects, device 103 operates as an interface for interacting with refined prompt generation system 110 via a user interface provided by refined prompt generation system 110 via computing devices 115. In aspects, device 103 may access refined prompt generation system 110 via any data network 106, such as the Internet. In certain aspects, refined prompt generation system 110 performs processes for generating modified prompts using one or more computing devices 115. The one or more computing devices 115 (sometimes referred to as “processing systems”) of refined prompt generation system 110 may include one or more processors and one or more non-transitory computer-readable mediums (e.g., memories) storing computer readable instructions that, when executed by the one or more processors, cause the one or more computing devices to perform processes defined by computer-readable instructions corresponding to one or more components depicted and described herein.

Refined prompt generation system 110 is further configured to communicate with (using one or more components described below) and leverage language model(s) 140. In some examples, described aspects utilize language models 140 that are hosted locally (e.g., within an organization's network domain) within refined prompt generation system 110. However, described aspects further include an API gateway 150 configured to enable refined prompt generation system 110 to interact with third-party hosted language models (e.g., by making API calls).

A language model is generally a type of machine learning model that is designed to understand, generate, and manipulate human language. More specifically, a language model is a probabilistic framework that determines the likelihood of a sequence of words or tokens. At its core, a language model attempts to predict the probability of the next word in a sentence given the preceding words. The model estimates these probabilities based on the patterns it learned during training. Language models are useful in natural language processing (NLP) and computational linguistics for performing a range of tasks involving human language.

Language models may be characterized by various components and capabilities. For example, a language model may include a vocabulary that defines the set of all possible words or tokens that the model can recognize and use. This includes common words, punctuation, and possibly domain-specific jargon. Language models may also consider a context, which refers to the preceding words in a sentence or sequence that the model uses to predict the next word. Modern language models often incorporate extensive context windows, leveraging entire sentences or even paragraphs.

Language model may be implemented in various ways. For example, N-gram models predict the next word based on the previous N-1 words. Neural network-based language models include Recurrent Neural Networks (RNNs), Long Short-Term Memory (LSTM) networks, and more Transformer models. These models capture more complex language patterns and context dependencies. The transformer architecture, introduced with models like BERT and GPT, utilizes self-attention mechanisms to handle long-range dependencies potentially more effectively than RNNs or LSTMs.

Language models are often trained using large corpora of text. The training process involves adjusting the model's parameters to minimize the difference between its predicted word probabilities and the actual word sequences in the training data. This is typically done via techniques like maximum likelihood estimation and gradient descent.

Language models have a wide array of applications, including: text generation (e.g., producing coherent and contextually appropriate text; machine translation (e.g., converting text from one language to another); speech recognition (e.g., converting spoken language into text); text summarization (e.g., condensing a long piece of text into a shorter summary); sentiment analysis (e.g., determining the sentiment expressed in a piece of text); and question answering (e.g., automatically providing answers to questions posed in natural language).

Thus, a language model is a sophisticated tool in NLP that analyzes and generates human language by understanding the probabilistic relationships between words and leveraging large datasets to learn these relationships. They form the backbone of many modern NLP applications, enabling machines to interpret, generate, and interact with human language.

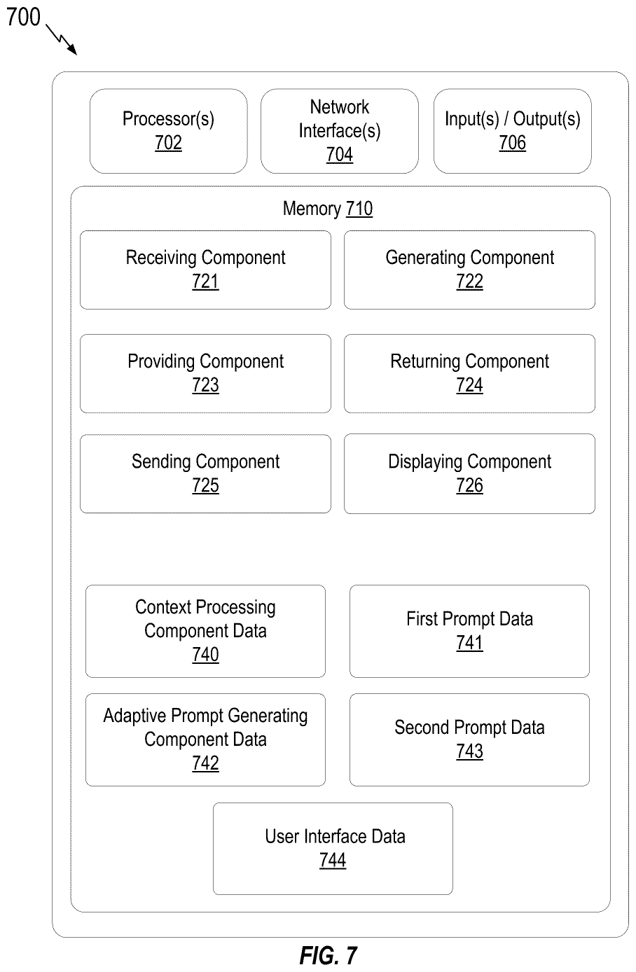

Refined prompt generation system 110 further includes a context processing component 120. Context processing component 120 may be configured to perform techniques described herein using one or more components of refined prompt generation system 110, for example, as provided via computing devices 115. Context processing component 120 is configured to receive an input 122 from user 101, for example, using a receiving component 721 with reference to FIG. 7. Input 122 may include a target prompt for processing by refined prompt generation system 110. As used herein, a “target prompt” refers to any set of instructions or written content designed for processing by a language model to generate a corresponding output, where the set of instructions or written content are provided by a user as an input for a refined prompt generation system in accordance with described aspects.

In some examples, input 122 may instead include a preliminary task description. As used herein, a “preliminary task description” refers to a generalized, human-facing outline of objectives, scope, and requirement for a task. As used herein “human-facing” refers to written content that is designed to be read, interpreted, and acted upon by a human rather than a language model. For example, a preliminary task description may include simple high-level statement outlining a primary goal or intended outcome for a given task without further providing specific instructions or formatting for causing a language model to perform the task and return expected outputs. For example, a preliminary task description may state “The goal is to create a concise summary of the provided text that captures the main points.” A corresponding target prompt may state “generate a concise summary of text based on the provided text that eliminates extraneous details, is no longer than one paragraph, uses plain language for a general audience, and using case-sentence formatting.” Refined prompt generation system 110 thus provides users with increased flexibility to generate modified prompts based on preliminary task descriptions, thereby reducing the additional investment to convert the preliminary task description into a target prompt incorporating additional details and more specific instructions.

Context processing component 120 is further configured to receive, from user 101, an expected output structure 124 corresponding to the input 122, for example using receiving component 721 with reference to FIG. 7. As used herein, an “expected output structure” refers to anticipated characteristics of generated outputs associated with a given target prompt or preliminary task description based on one or more specified output features. For example, an expected output structure for a target prompt may include one or more specified output features including, but not limited to, a specified format requirement, content requirement, tone, or length requirement.

Context processing component 120 is configured to pass received input 122 and corresponding expected output structure 124 into a PPTD generator 125. PPTD generator 125 is configured to generate a first prompt, for example, using a generating component (e.g., generating component 722 described below with reference to FIG. 7). The first prompt is configured to cause language model 140 to generate a PPTD for input 122. The first prompt may be generated based on a first prompt template, for example, using stored first prompt data 741 stored in a memory (e.g., memory 710 described below with reference to FIG. 7). As used herein a “prompt template” refers to a structured framework for generating one or more prompts that includes a set of instructions and a set of placeholders for inputting variable information, thereby enabling customization for each generated based on the specific inputs. For example, a prompt template may include placeholders for a received target prompt, and a corresponding received expected output structure, thereby ensuring the PPTD is generated further based on an expected output structure provided by user 101. After generating the first prompt, PPTD generator 125 provides the first prompt to language model 140, for example, using a providing component (e.g., providing component 723 described below with reference to FIG. 7).

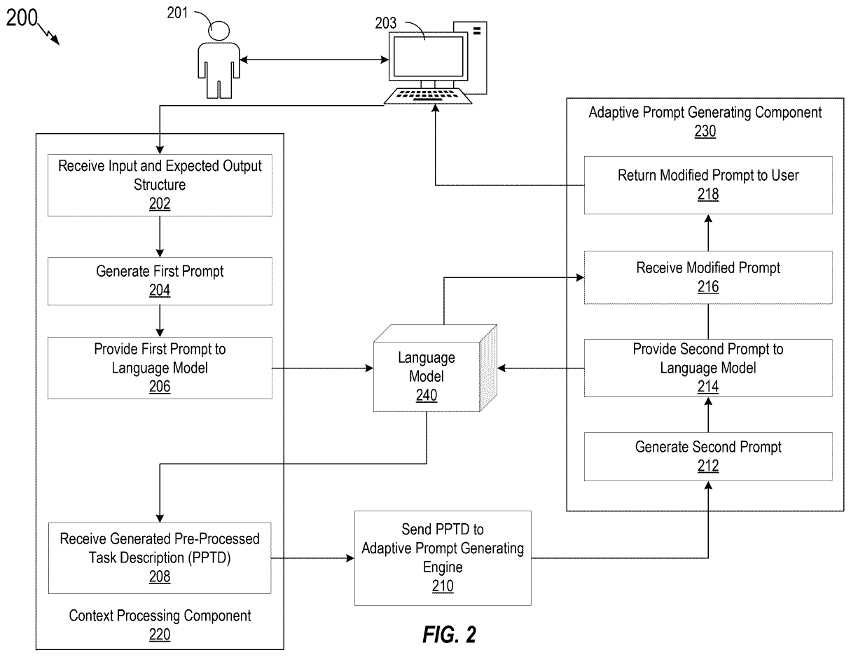

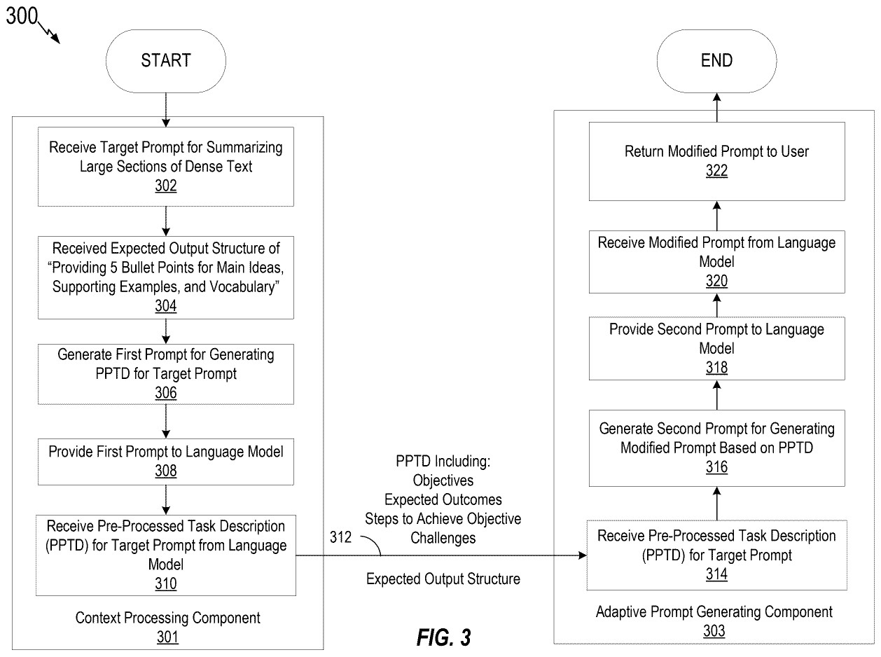

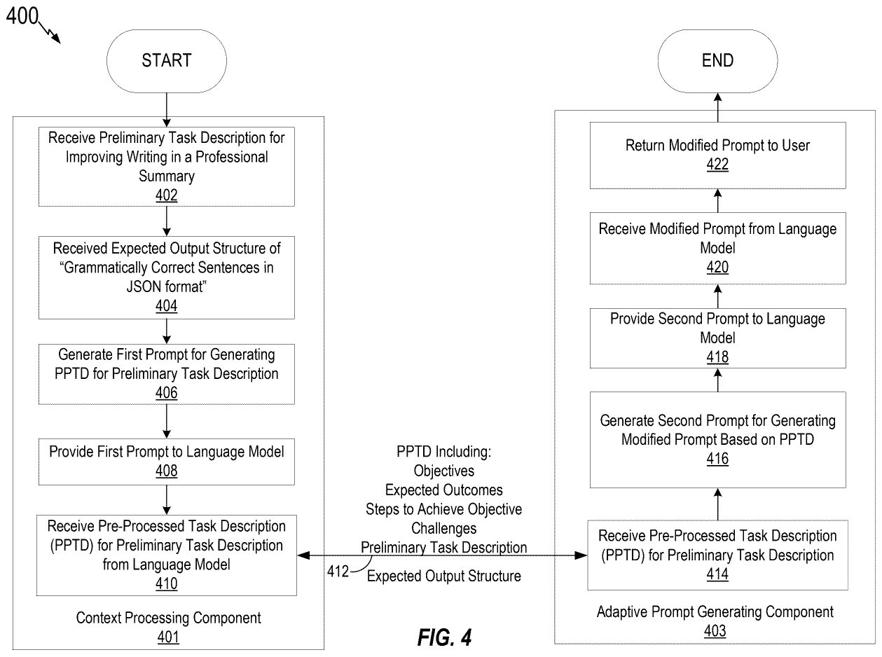

As discussed above, the PPTD generated by processing of the first prompt by the language model includes a set of refined instructions for magnifying structural and contextual features of a target prompt by focusing on at least objectives, steps for achieving the objectives, and expected outputs of the target prompt. Examples of PPTD generated by the first prompt and its use in generating modified prompts will be better understood in view of example process 200 described below with reference to FIG. 2, and in view of the example processes 300 and 400 described below with reference to FIGS. 3 and 4. PPTD generator 125 then sends the PPTD for the input 122 to a modified prompt generator 132 of an adaptive prompt generating component 130, for example, using a sending component (e.g., sending component 725 described below with reference to FIG. 7).

In addition to the PPTD, modified prompt generator 132 further receives input 122 and expected output structure 124 from context processing component 120, for example, using a receiving component (e.g., receiving component 721 described below with reference to FIG. 7). Modified prompt generator 132 is configured to generate a second prompt based on a second prompt template designed to incorporate each of the received PPTD, input 122, and expected output structure 124. Modified prompt generator 132 then provides the second prompt to language model 140, for example, using a providing component (e.g., providing component 723 described below with reference to FIG. 7). Language model 140 processes the second prompt to generate and return a modified prompt 134. The second prompt generated by modified prompt generator 132 PPTD thus causes language model 140 to generate modified prompts of increased quality which account for the additionally provided structural and contextual information within the PPTD and the expected output structure 124 for input 122.

In some examples, the second prompt generated by modified prompt generator 132 further causes language model 140 to proactively identify and address potential challenges based on input 122, expected output structure 124, and the generated PPTD. The second prompt thus causes language model 140 to return a modified prompt 134 including additional instructions for addressing anticipated challenges, thereby providing the benefit of ensuring modified prompt 134 produces outputs of increased quality while reducing computational costs and time required as compared to conventional techniques for generating modified prompts that reactively perform iterative prompt refinement based on reacting to unanticipated low quality output that arise due to a lack of context related to anticipated challenges.

Adaptive prompt generating component 130 then returns modified prompt 134 to user 101 via device 103, for example, a returning component (e.g., returning component 724 described below with reference to FIG. 7). In certain aspects, modified prompt 134 returned to user 101 may have increased compatibility with a language model type corresponding to language model 140. For example, input 122 may include a target prompt that is compatible with a language model “A” of a first language model type that is different from a second language model “B” of second language model type associated with language model 140. The modified prompt 134 generated using techniques performed by refined prompt generation system 110 will have increased compatibility with the second language model type associated with language model 140. Refined prompt generation system 110 provides flexibility in selection of an implemented language model type. Accordingly, refined prompt generation system 110 may be adjusted to implement a language model 140 of a specific type to generate modified prompts 134 having increased compatibility with the language model type of language model 140. Thus, refined prompt generation system 110 provides the technical benefit of increased portability as compared to conventional techniques for generating modified prompts that utilize machine learning and rule-based systems having model-specific limitations.

FIG. 2 depicts an example process 200 implementable by a refined prompt generation system for generating modified prompts according to one or more aspects.

At block 202, the refined prompt generation system begins the process by receiving input and a corresponding expected output structure, for example, using a receiving component (e.g., receiving component 721 described below with reference to FIG. 7). For example, the refined prompt generation system may receive the input and corresponding expected output structure from a user 201 interfacing with the refined prompt generation system using a device 103. In aspects, the refined prompt generation system is configured to provide a user interface for displaying one or more user interface features for enabling the user to manually input or upload one of a target prompt or a preliminary task description, for example using a displaying component (e.g., displaying component 726 described below with reference to FIG. 7). The provided user interface may similarly enable user 201 to manually input or uploaded expected output structures corresponding to the input target prompt or preliminary task description. For example, the refined prompt generation system may receive a target prompt including a portion of instructions corresponding to an objective stating “Summarize three key features of a smartphone”. The refined prompt generation system may further receive an expected output structure for the target prompt stating “1. List format with 3 numbered items. 2. Include content related to the display, processing power, and connectivity options. 3. Use a neutral and consumer-friendly tone. 4. Each item should be one sentence”. The example expected output structure indicates required characteristics for the generated output such as the required format, content requirements, tone requirements, and a required length.

At block 204, the refined prompt generation system generates a first prompt, for example using a context processing component 220 similar to context processing component 120 described above with reference to FIG. 1. The context processing component utilizes a first prompt template to generate the first prompt, incorporating the received input and corresponding expected output structure received at block 202. The first prompt may include instructions for causing a language model to generate a pre-processed task description for magnifying structural and contextual features of a prompt by focusing the set of refined instructions on least objectives, steps for achieving the objectives, and expected outputs for a target prompt being modified.

In certain examples, a portion of the first prompt may be configured to cause the language model to determine one or more anticipated challenges for generating high quality outputs for the input. As used herein, an “anticipated challenge” refers to a predicted feature or limitation associated with a risk of negatively impacting generated output for a received target prompt or preliminary task description based on the description of the objective, the step for achieving the objective, and/or the expected outcome. As an example, for the above target prompt having the objective “summarize three key features of a smartphone,” the first prompt generated by the context processing component may cause the language model to determine an example set of anticipated challenges for including in the PPTD that states, in part:
1. Generic Responses: Generated responses may provide vague descriptions like ‘great performance’ without detailing specifics (e.g. ‘powerful central processing unit for multitasking’). 2. Redundancy: Generated responses may repeat details across items instead of focusing on distinct features.

The example set of anticipated challenges in the PPTD may then be leveraged by an adaptive prompt generating component 230, such as when generating the second prompt, to provide additional context for generating a higher quality modified prompt to return to user 201.

At block 206, context processing component 220 provides the generated first prompt to a language model 240, for example such as using a providing component (e.g., providing component 723 described below with reference to FIG. 7). In aspects, context processing component 220 is configured to provide the first prompt to a locally hosted language model 240. In some examples, context processing component 220 may be configured to send prompts and receive generated output from language model 240 using one or more API calls, for example, using API gateway 150 described above with reference to FIG. 1. Language model 240 may then process the provided prompt to generate a PPTD for the received input based on its content and the associated expected output structure.

At block 208, the refined prompt generation system receives the generated PPTD from language model 240, for example using a receiving component (e.g., receiving component 721 described below with reference to FIG. 7). As discussed above, the PPTD is incorporated into a second generated prompt by an adaptive prompt generating component 230.

At block 210, the refined prompt generation system sends the received PPTD to adaptive prompt generating component 230, for example, using sending a component (e.g., sending component 725 described below with reference to FIG. 7).

At block 212, adaptive prompt generating component 230 generates a second prompt, for example, using a generating component (e.g., generating component 722 described below with reference to FIG. 7). The second prompt may be generated based on a second prompt template designed to incorporate the received PPTD including the objectives, steps for achieving the objectives, expected outputs, and anticipated challenges for the received target prompt or preliminary task description. The second prompt template further includes placeholders for incorporating the received expected output structure. The generated second prompt thus includes, for example, instructions configured to cause language model 240 to generate a modified prompt based at least the received input, the associated expected output structure, and the information contained in the PPTD. The expected output structure and information contained in the PPTD thus ensure the second generated prompt includes input-specific information for amplifying structural and contextual features of the input, such that processing of the generated second prompt by language model 240 will cause it to generate a modified prompt of improved quality for generating more precise and accurate outputs.

At block 214, adaptive prompt generating component 230 provides the generated first prompt to a language model 240, for example using a providing component (e.g., providing component 723 described below with reference to FIG. 7). For example, block 214 may be performed using similar means as described above at block 206. Language model 240 may then process the provided second prompt to generate a modified prompt corresponding to the received input.

At block 216, adaptive prompt generating component 230 receives the generated modified prompt from language model 240, for example using a receiving component (e.g., receiving component 721 described below with reference to FIG. 7).

At block 218, the refined prompt generation system returns the generated modified prompt to user 201, for example using a returning (e.g., returning component 724 with reference to FIG. 7). For example, the refined prompt generation system may return the generated modified prompt to user 201 via a provided user interface with which user 201 may interface with using device 203.

FIG. 3 depicts an example process implementable by a refined prompt generation system (e.g., refined prompt generation system 110 of FIG. 1) for generating modified prompts based on an input target prompt according to one or more aspects.

At block 302, a context processing component 301 of the refined prompt generation system receives input from a user including, for example, a target prompt including instructions for causing a language model to summarize large sections of dense text, for example, using a receiving component (e.g., receiving component 721 described below with reference to FIG. 7). For example, the instructions of the received target prompt may be formulated as follows:
You are an expert educator with superb comprehension and communication skills, skilled in reading, understanding, and summarizing the main points of large sections of dense texts. The following text is from a writing class and is about professional writing. Your task is to summarize the text, providing 5 bullet points for the main ideas, steps, and vocabulary.

At block 304, context processing component 301 receives an expected output structure associated with the received target prompt, for example, using a receiving component (e.g., receiving component 721 with reference to FIG. 7). The expected output structure may include additional features related to format and presentation, content requirements, tone and style, length and clarity, prioritization, or other features that may impact expected output structure. For example, the received expected output structure received from the user may be formulated as follows:
The generated output should be provided as bullet points. Use no more than two sentences per bullet point. Avoid sub-bullets or nested lists. Maintain a professional yet accessible tone. Each bullet should not exceed 30 words. Focus on concepts or details emphasized in the original text, avoiding minor or peripheral content.

At block 306, context processing component 301 generates a first prompt configured to cause a language model to generate a PPTD for the target prompt received at block 202, for example, using a generating component (e.g., generating component 722 described below with reference to FIG. 7). The first prompt may be generated by incorporating instructions for causing the language model to leverage the target prompt from block 302, and the expected output structure at block 304. The first prompt may further include instructions for causing the language model to determine, and include within the PPTD, one or more anticipated challenges for the target prompt.

At block 308, context processing component 301 provides the first prompt to the language model, for example using a providing component (e.g., providing component 723 described below with reference to FIG. 7). As described above, in some examples the context processing system may provide the first prompt to a locally-hosted language model. In other examples, the context processing system sends the first prompt to a third party language model using one or more API calls, for example, using API gateway 150 described above with reference to FIG. 1.

At block 310, context processing component 301 receives the PPTD for the input target prompt from the language model, for example using a receiving component (e.g., receiving component 721 described with reference to FIG. 7). The received PPTD may include one or more of objectives, expected outcomes, steps to achieve the objective, anticipated challenges based on the target prompt and the associated expected output structure.

For the example target prompt of example process 300, the objectives in the received PPTD may state:
“Objective: Summarize the provided text from a writing class focused on professional writing, capturing the main ideas, steps, and vocabulary in a clear and concise manner”

The PPTD for the target prompt of example process 300 may further include expected outcomes stating the following:
You will deliver a summary consisting of five bullet points that encapsulate the main ideas, steps, and vocabulary relevant to the text. The output will be structured as follows: {“Output”: [‘Bullet Point 1’, ‘Bullet Point 2’, ‘Bullet Point 3’, ‘Bullet Point 4’, ‘Bullet Point 5’]}

In the same example, the steps for achieving the objective contained within the received PPTD may state the following:
Read the Text Thoroughly: Begin by reading the entire section carefully to grasp the overall message and key concepts.
Identify Main Ideas: Highlight or note down the central themes and supporting details within the text.
Extract Key Vocabulary: Look for important terms and phrases that are critical to understanding the topic.
Summarize in Bullet Points: Condense the identified main ideas, steps, and vocabulary into five concise bullet points.
Review for Clarity: Ensure that each bullet point is clear, precise, and accurately reflects the content of the original text.

The received PPTD for the target prompt of example process 300 may further include a set of anticipated challenges stating the following:
Dense Texts: The complexity of the text might make it challenging to distill information. To address this, break the text into smaller sections and summarize each before combining them.
Subjectivity in Main Ideas: Identifying the most significant points can be subjective. To mitigate this, refer to any provided guidelines or discussion prompts that highlight key areas of focus.
Maintaining Conciseness: It may be difficult to convey all critical information succinctly. Practice prioritizing information that is essential for understanding the topic and omit extraneous details.

The example received PPTD described above thus contains significant prompt-specific context associated with the target prompt. Each section of the PPTD is tailored and focused, isolating context for each of the objectives and steps to be performed, while proactively identifying anticipated challenges to be considered during subsequent generation of a modified prompt associated with the target prompt.

At block 312, context processing component 301 sends the received PPTD to an adaptive prompt generating component 303, for example, using a sending component (e.g., sending component 725 described below with reference to FIG. 7). Adaptive prompt generating component 303 may be similar to the illustrative adaptive prompt generating component 130 described above with reference to FIG. 1, and adaptive prompt generating component 230 described above with reference to FIG. 2.

At block 314, the adaptive prompt generating component 303 receives the PPTD from the context processing component 301, for example, using a receiving component (e.g., receiving component 721 described below with reference to FIG. 7).

At block 316, the adaptive prompt generating component 303 generates a second prompt configured to cause a language model to generate a modified prompt based on the received PPTD, for example, using a generating component (e.g., generating component 722 with reference to FIG. 7). For example, the second prompt may be generated by the adaptive prompt generating component 303 based on a second prompt template including placeholders for at least the received PPTD and the received expected output structures for the target prompt. The expected output structure and information contained in the PPTD thus ensure the second generated prompt includes input-specific information (in this case, for the received target prompt) for amplifying structural and contextual features of the input, such that processing of the generated second prompt by language model 240 will cause it to generate a modified prompt of improved quality for generating more precise and accurate outputs.

At block 318, the adaptive prompt generating component 303 provides the generated second prompt to the language model for processing, for example, using a providing component (e.g., providing component 723 described below with reference to FIG. 7).

At block 320, the adaptive prompt generating component 303 receives the modified prompt from the language model, for example, using a receiving component (e.g., receiving component 721 described below with reference to FIG. 7). As an example, the modified prompt received from the language model may include at least the following instructions related to the objective, steps to achieve the objective, expected output structure, and anticipated challenges:
You are tasked with summarizing the provided text from a writing class focused on the topic of professional writing. Your summary should capture the main ideas, steps, and key vocabulary in a clear and concise manner.
Please follow these steps:
1. **Read the Text Thoroughly:** Analyze the entire section to understand the overall message and key concepts.
2. **Identify Main Ideas:** Highlight the central themes and supporting details within the text.
3. **Extract Key Vocabulary:** Identify important terms and phrases critical to understanding the topic.
4. **Summarize in Bullet Points:** Condense the identified main ideas, steps, and vocabulary into five concise bullet points.
5. **Review for Clarity:** Ensure each bullet point is clear, precise, and accurately reflects the content of the original text.
Your output should consist of five bullet points structured as follows:
**{“Output”: [‘Bullet Point 1’, ‘Bullet Point 2’, ‘Bullet Point 3’, ‘Bullet Point 4’, ‘Bullet Point 5’]}**
Remember to address challenges such as dense texts, subjectivity in main ideas, and maintaining conciseness. Prioritize essential information for a comprehensive yet concise summary.

As demonstrated by the above example, the generated modified prompt incorporates elements of the target prompt, the received expected output structure, and the received PPTD generated by the language model. The modified prompt includes instructions that highlight and amplify the contextual information and required output structure, ensuring the modified prompt may be used to generate precise and accurate outputs. The modified prompt further includes instructions for ensuring a language model processing the modified prompt addresses anticipated challenges, thereby proactively avoiding certain complicating features for performing the objective that may negatively impact the quality of generated outputs. For example, the modified prompt ensures the language model considers and addresses the density of the text, subjectivity in main ideas, maintaining conciseness, and prioritizing of essential information for a comprehensive yet concise summary. Accordingly, a refined prompt generation system in accordance with described aspects generates modified prompts that have more comprehensive structural and content-specific context while proactively addressing anticipated challenges, thereby reducing computational costs and time required as compared to conventional techniques for generating modified prompts that reactively perform iterative prompt refinement based on reacting to unanticipated low quality outputs.

At block 322, adaptive prompt generating component 303 returns the modified prompt to the user, for example, using a returning component (e.g., returning component 724 described below with reference to FIG. 7). For example, adaptive prompt generating component 303 may return the modified prompt using similar means as described above at block 218 of example process 200 with reference to FIG. 2.

FIG. 4 depicts an example process 400 implementable by a refined prompt generation system for generating modified prompts based on an input preliminary task description according to one or more aspects. Certain steps of process 400 are substantially similar to those described above in connection with at least processes 300 of FIG. 3. More specifically, certain described features of blocks 402-422 of process 400 are substantially similar to previously described blocks 302-322 of process 300.

At block 402, a context processing component 401 receives an input from a user including a preliminary task description for improving writing in a professional summary, such as for a professional resume. As an example, the received preliminary task description may state: “Rewrite the provided text into a clear, grammatically correct version while preserving its original meaning. Correct spelling, punctuation, verb tense, word choice, and other grammatical issues.”

At block 404, context processing component 401 receives an expected output structure for the preliminary task description. An example expected output structure for the received preliminary task description from block 402 may state “Generate outputs including grammatically correct sentences in JavaScript Object Notation (JSON) format.”

At block 406, context processing component 401 generates a first prompt for causing a language model to generate a PPTD for the received preliminary task description. Context processing component 401 generates the first prompt using similar means as described at block 306 with reference to FIG. 3. However, the first prompt generated by context processing component 401 may further include instructions for causing the language model to specifically modify the characteristics of the received preliminary task description to incorporate additional instructions, formatting, or other linguistic features for supporting increased compatibility with the employed language model. For example, the generated first prompt may include additional instructions for causing the language model to clarify grammar and style goals, to set boundaries for edits, or to set quality standards. The additional instructions in the first prompt may cause the PPTD generated by the language model to include additional features for improving accuracy and precision of outputs generated by an associated modified prompt generated based on the PPTD. For example, the additional instructions for clarifying grammar and style goals may cause the language model to provide instructions within the generated PPTD stating: “Ensure a formal tone if the text is academic or professional.” As another example, the additional instructions for setting boundaries for edits may cause the language model to provide instructions within the generated PPTD stating “Avoid unnecessary changes, such as altering technical terms, idiomatic expressions, or domain-specific language unless they are grammatically incorrect.”

At 408, context processing component 401 provides the first prompt to the language model. Context processing component 401 provides the first prompt using similar means as described above at block 308 of example process 300 with reference to FIG. 3.

At 410, context processing component 401 receives the PPTD for the preliminary task description from the language model. Context processing component 401 receives the PPTD using similar means as described above at block 310 of example process 300 with reference to FIG. 3. The received PPTD for the preliminary task description input at block 402 may include the following task objective:
Task Objective
The primary objective of this task is to refine and enhance a given piece of text by rewriting it into a clear and grammatically correct format. The aim is to preserve the original meaning while correcting any spelling, punctuation, verb tense, word choice, and other grammatical inaccuracies.

The received PPTD may further include the following steps for achieving the objective:
Steps to Achieve the Objective
Initial Review: Begin by thoroughly reading the provided text to understand its context, meaning, and the key messages it conveys.
Identification of Errors: Systematically identify grammatical issues within the text. This includes spotting errors in spelling, punctuation, verb tense consistency, improper word choice, and sentence structure problems.
Correction Process:
Spelling and Punctuation: Correct any spelling mistakes and ensure that punctuation is used correctly to enhance readability.
Verb Tense Consistency: Check that the verb tense remains consistent throughout the text to avoid confusion.
Word Choice: Evaluate the word choice to ensure clarity and appropriateness, replacing any vague or incorrect words with more suitable alternatives.
Sentence Structure: Revise sentence structures to improve flow and coherence, making sure that each sentence logically follows from the previous one.
Rewriting: After identifying and correcting the issues, rewrite the text in a coherent and grammatically correct manner, ensuring that the essence and meaning are preserved.
Final Review: Conduct a final read-through of the rewritten text to ensure that all corrections have been made and that the text is clear and fluent.

The received PPTD may further include the following expected outcomes:
Expected Outcomes
Upon completing the task, the following outcomes are anticipated:
The rewritten text will be free of grammatical errors, enhancing clarity and professionalism.
The original meaning of the text will be maintained, ensuring that key messages are effectively communicated.
The overall readability of the text will be improved, making it more accessible to the intended audience.

In certain aspects, the first prompt may further be configured to cause the language model to return a PPTD including additional features, such one or more proposed supplemental resources for achieving an objective, or one or more mechanisms for quantifiably measuring results with respect to an objective. As used herein “proposed supplemental resources” may refer to one or more additional techniques or tools (e.g. software, sample texts, style guidelines, feedback data, etc.) useful for enhancing the quality of generated outputs or the efficiency of obtaining the generated outputs for a given target prompt or preliminary task description. For example, the received PPTD at block 410 may further include the following anticipated innovative solutions and mechanisms for quantifiably measuring results for the objective provided above:
Proposed Supplemental Resources
This task can be enhanced through the use of advanced language processing tools and software. By integrating spelling and grammar checking tools, such as AI-driven grammar checkers, the process can be expedited and made more accurate. Additionally, employing collaborative feedback mechanisms, where peers can review changes, may lead to further improvements in the quality of the rewritten text.
Proposed Quantifiable Measurements
While specific quantitative results may vary depending on the initial quality of the text, improvements could be measured in terms of:
Percentage of Grammatical Errors Corrected: A target could be set for achieving at least a 90% reduction in identified grammatical issues.
Time Savings: Utilizing tools may reduce the time taken for revisions by approximately 30% compared to manual proofreading.
Readability Score Improvement: A measurable enhancement in readability scores (such as Flesch-Kincaid scores) could indicate greater clarity and ease of understanding.

At block 412, context processing component 401 sends the received PPTD and the received expected output structure to an adaptive prompt generating component 403. Context processing component 401 sends the PPTD and the expected output structure using similar means as described above at block 312 of example process 300 with reference to FIG. 3.

At block 414, adaptive prompt generating component 403 receives the PPTD and the expected output structure from the context processing component 301. Adaptive prompt generating component 403 receives the PPTD and the expected output structure using similar means as described above at block 314 of example process 300 with reference to FIG. 3.

At block 416, adaptive prompt generating component 403 generates a second prompt for causing the language model to generate a modified prompt based on the received PPTD and expected output structure. Adaptive prompt generating component 403 receives the PPTD and expected output structure using similar means as described above at block 316 of example process 300 with reference to FIG. 3.

At block 418, adaptive prompt generating component 403 provides the generated second prompt to the language model. Adaptive prompt generating component 403 sends the generated second prompt to the language model using similar means as described above at block 318 of example process 300 with reference to FIG. 3.

At block 420, adaptive prompt generating component 403 receives the modified prompt from the language model. Adaptive prompt generating component 403 receives the modified prompt from the language model using similar means as described above at block 320 of example process 300 with reference to FIG. 3. For the example preliminary task description, associated expected output structure, and received PPTD discussed above, the modified prompt received at block 420 may state the following:
Refine and enhance the provided text by rewriting it into a clear and grammatically correct format. Ensure that the original meaning is preserved while correcting any spelling, punctuation, verb tense, word choice, and other grammatical inaccuracies. Follow these steps:
1. **Initial Review**: Read the text to understand its context and key messages.
2. **Identification of Errors**: Identify grammatical issues including spelling, punctuation, verb tense consistency, word choice, and sentence structure problems.
3. **Correction Process**:
   Correct spelling and punctuation errors to enhance readability.
   Ensure verb tense consistency throughout the text.
      Evaluate and improve word choice for clarity and appropriateness.
   -Revise sentence structures for better flow and coherence.
4. **Rewriting**: Rewrite the text to ensure it is coherent and grammatically correct while maintaining the essence of the original message.
5. **Final Review**: Conduct a read-through to confirm that all corrections have been made and the text is clear and fluent.
*Input: ** {original_text}
*Expected Output Format:**
‘‘‘json
{“Output”: “Grammatically correct sentence”}’’’

At block 422, the modified prompt is returned to the user using similar means as described above with reference to block 322 of process 300 described above with reference to FIG. 3. Accordingly, the refined prompt generation system provides a user with flexibility to generate a modified prompt including detailed instructions informed by prompt-specific context and expected output structures based on an input preliminary task description.

Refined prompt generation systems in accordance with described aspects are further useful for generating modified prompts having increased compatibility with a language model type corresponding to an employed language model.

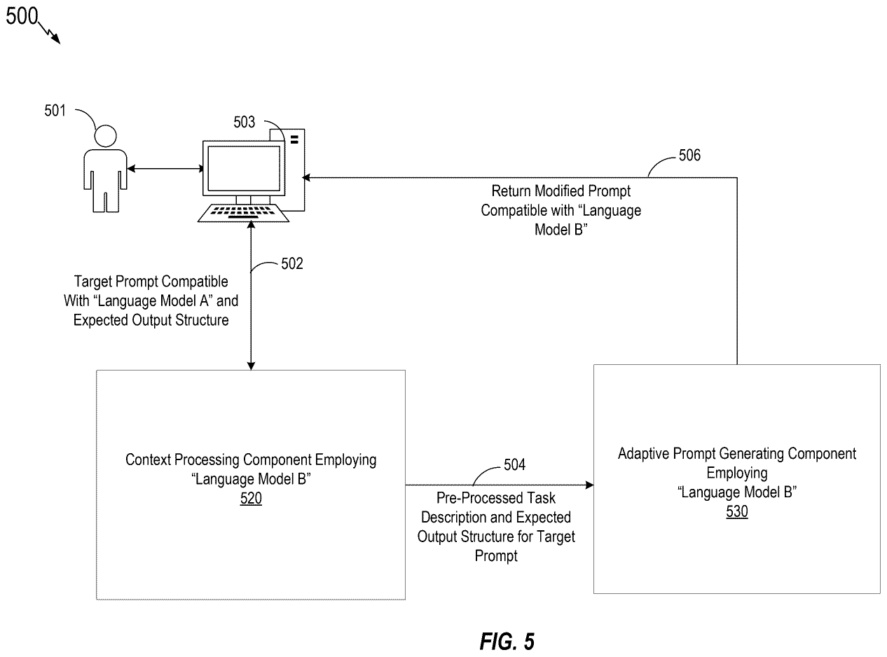

FIG. 5 depicts an example process 500 implementable by a refined prompt generation system for generating modified prompts having increased compatibility with an employed language model according to one or more aspects.

At 502, a target prompt designed to be compatible with a “Language Model A” of a first language model type is received by a context processing component 520 in accordance with described refined prompt generation systems employing a “Language Model B” of a second language model type. For example, context processing component 520 may be configured to perform methods described herein using similar means as context processing component 120 described above with reference to FIG. 1, and context processing component 220 described above with reference to FIG. 2.

As used herein a “language model type” refers to one or more a specific architecture, configuration, or set of features used to build a language model which may dictate one or more of the language model's behaviors, strengths, limitations, and compatibility with certain tasks of a given input. For example, language model types may include transformer-based models that rely on attention mechanisms to process sequences of text, autoregressive models that generate text by predicting a next token in a sequence based on prior tokens, masked language models for predicting masked words, encoder-decoder models for using an encoder to process inputs and a decoder to generate outputs for translation or summarization, or any other model types currently known or yet to be developed.

As used herein “compatibility” may refer to how well a target prompt aligns with the architecture, training objectives, and operational strengths of a specific language model type, influencing the accuracy and efficiency of generated outputs. In examples, a given prompts compatibility with a selected language model type may be quantifiably measured by calculating a compatibility score based on what percentage of test outputs exceed an evaluation metric. In certain aspects, a predetermined compatibility threshold for evaluating a prompt may be based on one or more evaluation metrics for generated test outputs such as an accuracy score of generated outputs, a coherence score, a task completion score, and an error rate score. Additional or fewer evaluation metrics may be considered as may be relevant for different prompt objectives, steps performed, or requirements included. As an example, a batch of test outputs may be evaluated to obtain heuristic-based scores for each evaluation metric. The obtained scores may then be aggregated and normalized to obtain a final score between 0-100, where 0 indicates a failure of any of the generated test outputs to meet a one or more evaluation metrics, and 100 indicates that each of the generated outputs satisfied all evaluation metrics. In some examples, a compatibility threshold based on aggregated and normalized compatibility scores for a set of generated test outputs (e.g., greater than or equal to 70) may be used to determine whether a prompt is compatible with a given language model type.

Compatibility scores may be obtained through manual evaluation, or using prompt-based mechanisms. For example, a fine-tuned transformer model may be trained to perform heuristic-based scoring tests based on a set of learned criteria relevant to a specific domain or set of tasks and objectives by using an evaluator prompt to generate compatibility scores for one or more prompts with respect to one or more language model types. The compatibility scores obtained by the evaluator prompt for a target prompt and a modified prompt generated using techniques in accordance with described aspects may then be compared to determine whether the modified prompt has increased compatibility with an employed language model type.

At 504, a generated PPTD and received expected output structure for the target prompt are sent to an adaptive prompt generating component 530 employing “Language Model B.” Adaptive prompt generating component 530 is configured to perform described processes of generating a second prompt configured to cause a language model to generate a modified prompt based on the PPTD and the received expected output structure using similar means at adaptive prompt generating component 130 described above with reference to FIG. 1, and adaptive prompt generating component 230 described above with reference to FIG. 2.

At 506, adaptive prompt generating component 530 returns a received modified prompt having increased compatibility with employed “Language Model B” as compared to the target prompt received at 502. For example, a set of compatibility scores for batch of test outputs associated with the returned modified prompt may be compared to a set of compatibility scores for batch of test outputs associated with the target prompt using techniques described above. The compatibility scores for the generated modified prompt will be increased for the second language model type corresponding to employed “Language Model B.” As such, described refined prompt generation systems generate modified prompts having increased compatibility with an employed language model type regardless of the compatibility features of the target prompt.

By generating specially designed prompts that focus on leveraging task descriptions and expected output structures derived from a target prompt, refined prompt generation systems in accordance with described aspects may employ a language model of a specific type to consistently and effectively generate modified prompts having increased compatibility with the employed language model type. This may be useful for migrating historical prompts (compatible with a previously employed language model) with a subsequently employed language model of a different type. In other words, described aspects may employ a selected language model of a given language model type as may desirable for processing generated first and second prompts (such as generated in accordance with processes 200, 300, and 400 described above with reference to FIGS. 2-4) to cause the language model to generate modified prompts having increased compatibility with a specific employed language model. Thus, described aspects further provides the technical benefit of increased model agnosticism and portability as compared to conventional techniques for generating modified prompts that utilize machine learning and rule-based systems having model-specific limitations.

### Example Method for Generating Modified Prompts

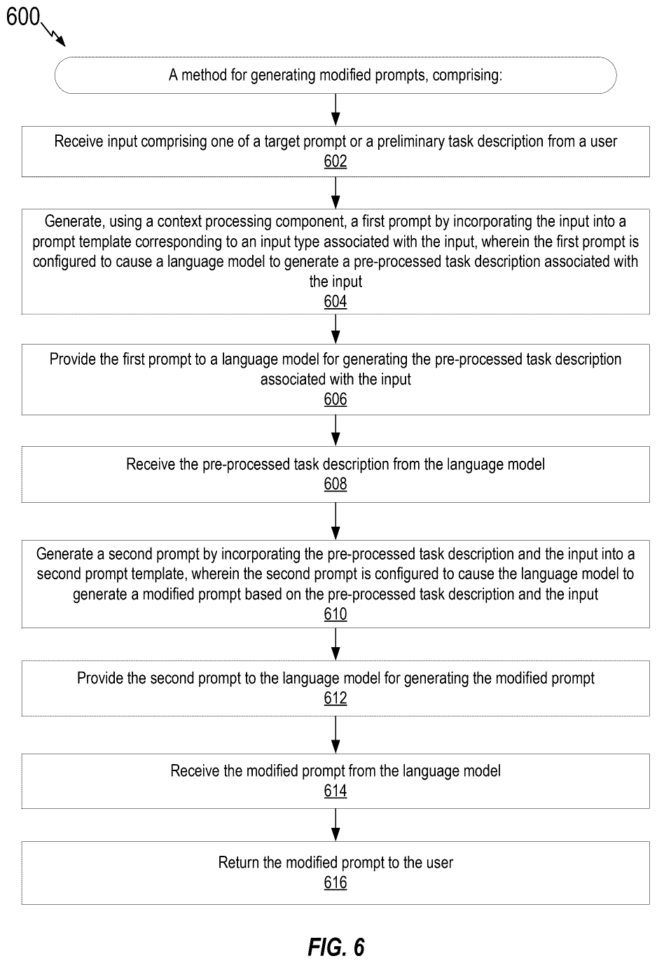

FIG. 6 depicts an example method 600 for generating test functions for prompt evaluation and refinement according to one or more aspects.

Method 600 begins at block 602 with receiving input comprising one of a target prompt or a preliminary task description from a user. For example, block 602 may be performed by the one or more processing systems 700 described below with reference to FIG. 7, configured to implement components including, but not limited to, a receiving component 721. As another example, block 602 may be performed by context processing component 120 described above with reference to FIG. 1 for performing corresponding processes, for example, corresponding to at least block 202 of process 200 described above with reference to FIG. 2.

Method 600 then proceeds to block 604 with generating, using a context processing component, a first prompt by incorporating the input into a prompt template corresponding to an input type associated with the input, wherein the first prompt is configured to cause a language model to generate a pre-processed task description associated with the input. For example, block 604 may be performed by the one or more processing systems 700 described below with reference to FIG. 7, configured to implement components including, but not limited to, a generating component 722. As another example, block 604 may be performed by context processing component 120 described above with reference to FIG. 1 for performing corresponding processes, for example, corresponding to at least block 204 of process 200 described above with reference to FIG. 2.

Method 600 then proceeds to block 606 with providing the first prompt to a language model for generating the pre-processed task description associated with the input. For example, block 606 may be performed by the one or more processing systems 700 described below with reference to FIG. 7, configured to implement components including, but not limited to, a providing component 723. As another example, block 606 may be performed by context processing component 120 described above with reference to FIG. 1 for performing corresponding processes, for example, corresponding to at least block 206 of process 200 described above with reference to FIG. 2.

Method 600 then proceeds to block 608 with receiving the pre-processed task description from the language model. For example, block 608 may be performed by the one or more processing systems 700 described below with reference to FIG. 7, configured to implement components including, but not limited to, a receiving component 721. As another example, block 602 may be performed by context processing component 120 described above with reference to FIG. 1 for performing corresponding processes, for example, corresponding to at least block 208 of process 200 described above with reference to FIG. 2.

Method 600 then proceeds to block 610 with generating a second prompt by incorporating the pre-processed task description and the input into a second prompt template, wherein the second prompt is configured to cause the language model to generate a modified prompt based on the pre-processed task description and the input. For example, block 610 may be performed by the one or more processing systems 700 described below with reference to FIG. 7, configured to implement components including, but not limited to, generating component 722. As another example, block 610 may be performed by modified prompt generator 132 of adaptive prompt generating component 130 described above with reference to FIG. 1 for performing corresponding processes, for example, corresponding to at least block 212 of process 200 described above with reference to FIG. 2.

Method 600 then proceeds to block 612 with providing the second prompt to the language model for generating the modified prompt. For example, block 612 may be performed by the one or more processing systems 700 described below with reference to FIG. 7, configured to implement components including, but not limited to, providing component 723. As another example, block 612 may be performed by adaptive prompt generating component 130 described above with reference to FIG. 1 for performing corresponding processes, for example, corresponding to at least block 214 of process 200 described above with reference to FIG. 2.

Method 600 then proceeds to block 614 with receiving the modified prompt from the language model. For example, block 614 may be performed by the one or more processing systems 700 described below with reference to FIG. 7, configured to implement components including, but not limited to, receiving component 721. As another example, block 614 may be performed by adaptive prompt generating component 130 described above with reference to FIG. 1 for performing corresponding processes, for example, corresponding to at least block 216 of process 200 described above with reference to FIG. 2

Method 600 then proceeds to block 616 with providing the second prompt to the language model for generating the modified prompt. For example, block 616 may be performed by the one or more processing systems 700 described below with reference to FIG. 7, configured to implement components including, but not limited to, providing component 723. As another example, block 616 may be performed by adaptive prompt generating component 130 described above with reference to FIG. 1 for performing corresponding processes, for example, corresponding to at least block 218 of process 200 described above with reference to FIG. 2

In some aspects, method 600 further includes receiving, from the user, an expected output structure for the input.

In some aspects, the first prompt is generated by further incorporating the expected output structure for the input.

In some aspects, the pre-processed task description associated with the input comprises one or more of a description of an objective, a step for achieving the objective, and an expected outcome.

In some aspects, the pre-processed task description associated with the input further comprises instructions for one or more anticipated challenges based on the one or more of the description of the objective, the step for achieving the objective, and the expected outcome.

In some aspects, the first prompt further causes the language model to remove noise and ambiguous language from the input.

In some aspects, the second prompt is generated further based on the one or more of the description of the objective, the step for achieving the objective, and the expected outcome from the pre-processed task description.

In some aspects, the input is associated with a first compatibility score below for a language model type corresponding to the language model.

In some aspects, the modified prompt is associated with a second compatibility score for the language model type corresponding to the language model, the second compatibility score being greater than the first compatibility score and above a predetermined compatibility threshold.

In some aspects, the pre-processed task description further comprises one or more proposed supplemental resources for enhancing a quality of generated outputs associated with the received input.

Method 600 thus provides technical solutions to overcome shortcomings of conventional techniques for generating modified prompts. More specifically, method 600 utilizes specially designed prompts to generate a PPTD for an input, and then leverage the generated PPTD to cause a language model to proactively identify potential challenges and edge cases when generating modified prompts. Proactively identifying challenges and edge cases improves precision and accuracy of the outputs generated by a language model processing the modified prompts generated. In addition, the modified prompts generated by described aspects performing method 600 further provide the technical benefit of reducing computational costs and time required as compared to conventional techniques for reactively generating modified prompts based on reacting to unanticipated low quality outputs. Method 600 further provide a fully automated framework for generating modified prompts, thereby providing the technical benefit of increased scalability for performing prompt refinement while reducing required costs and human capital as compared to conventional techniques employing prompt engineers. In certain examples, method 600 is further useful for generating a modified prompt having improved compatibility with an employed language model type. For example, method 600 may be used to generate a modified prompt having increased compatibility with a language model top of an employed language model as compared to the input target prompt or preliminary task description. Accordingly, method 600 further provides the technical benefit of increased model agnosticism and portability as compared to conventional techniques for generating modified prompts that utilize machine learning and rule-based systems having model-specific limitations which prevent them from effectively generating modified prompts for certain inputs that are only compatible with specific model types.

FIG. 6 is just one example of a method, and other methods including fewer, additional, or alternative steps are possible consistent with this disclosure.

### Example Processing System for Generating Modified Prompts

FIG. 7 depicts an example processing system 700 upon which one or more aspects shown and described herein may be implemented.

The processing system 700 includes one or more processors 702. Generally, processor(s) 702 may be configured to execute computer-executable instructions (e.g., software code) to perform various functions, as described herein.

The processing system 700 further includes a network interface(s) 704, which generally provides data access to any sort of data network, including personal area networks (PANs), local area networks (LANs), wide area networks (WANs), the Internet, and the like.

The processing system 700 further includes input(s) and output(s) 706, which generally provide means for providing data to and from the processing system 700, such as via connection to computing device peripherals, including user interface peripherals.

The processing system 700 further includes one or more memories 710. Memory(s) 710 are configured to store various types of components and data.

In this example, memory 710 includes a receiving component 721, a generating component 722, a providing component 723, a returning component 724, a sending component 725, and a displaying component 726.

Receiving component 721 may be configured to perform processes, for example, corresponding to blocks 602, 608, and 614 of method 600 described above with reference to FIG. 6. Receiving component 721 may further be configured to perform processes, for example, corresponding to at least blocks 202, 208, and 216 of process 200 described above with reference to FIG. 2.

Generating component 722 may be configured to perform processes, for example, corresponding to blocks 604 and 610 of method 600 described above with reference to FIG. 6. Generating component 722 may further be configured to perform processes, for example, corresponding to at least blocks 204 and 212 of process 200 described above with reference to FIG. 2.

Providing component 723 may be configured to perform processes, for example, corresponding to blocks 606 and 612 of method 600 described above with reference to FIG. 6. Receiving component 721 may further be configured to perform processes, for example, corresponding to at least blocks 206 and 214 of process 200 described above with reference to FIG. 2.

Returning component 724 may be configured to perform processes, for example, corresponding to block 616 of method 600 described above with reference to FIG. 6. Returning component 724 may further be configured to perform processes, for example, corresponding to at least block 218 of process 200 described above with reference to FIG. 2.

Sending component 725 may be configured to perform processes, for example, corresponding to block 210 of process 200 described above with reference to FIG. 2.

Displaying component 726 may be configured to perform processes, for example, corresponding to at least block 202 of process 200 described above with reference to FIG. 2.

In this example, memory 710 also includes context processing component data 740, first prompt data 741, adaptive prompt generating component data 742, second prompt data 743, and user interface data 744.

The processing system 700 may be implemented in various ways. For example, the processing system 700 may be implemented within on-site, remote, or cloud-based computing devices.

The processing system 700 is just one example, and other configurations are possible. For example, in alternative aspects, aspects described with respect to the processing system 700 may be omitted, added, or substituted for alternative aspects.

### Example Clauses

Implementation examples are described in the following numbered clauses:
Clause 1: A method for generating modified prompts, comprising: receiving input comprising one of a target prompt or a preliminary task description from a user; generating, using a context processing component, a first prompt by incorporating the input into a prompt template corresponding to an input type associated with the input, wherein the first prompt is configured to cause a language model to generate a pre-processed task description associated with the input; providing the first prompt to a language model for generating the pre-processed task description associated with the input; receiving the pre-processed task description from the language model; generating a second prompt by incorporating the pre-processed task description and the input into a second prompt template, wherein the second prompt is configured to cause the language model to generate a modified prompt based on the pre-processed task description and the input; providing the second prompt to the language model for generating the modified prompt; receiving the modified prompt from the language model; and returning the modified prompt to the user.
Clause 2: The method of Clause 1, further comprising receiving, from the user, an expected output structure for the input.
Clause 3: The method of Clause 2, wherein the first prompt is generated by further incorporating the expected output structure for the input.
Clause 4: The method of any one of Clauses 1-3, wherein the pre-processed task description associated with the input comprises one or more of a description of an objective, a step for achieving the objective, and an expected outcome.
Clause 5: The method of any one of Clauses 1-4, wherein the pre-processed task description associated with the input further comprises instructions for one or more anticipated challenges based on the one or more of the description of the objective, the step for achieving the objective, and the expected outcome.
Clause 6: The method of any one of Clauses 1-5, wherein the first prompt further causes the language model to remove noise and ambiguous language from the input.
Clause 7: The method of any one of Clauses 1-6, wherein the second prompt is generated further based on the one or more of the description of the objective, the step for achieving the objective, and the expected outcome from the pre-processed task description.
Clause 8: The method of any one of Clauses 1-7, wherein the input is associated with a first compatibility score below for a language model type corresponding to the language model.
Clause 9: The method of any one of Clauses 1-8, wherein the modified prompt is associated with a second compatibility score for the language model type corresponding to the language model, the second compatibility score being greater than the first compatibility score and above a predetermined compatibility threshold.
Clause 10: The method of any one of Clauses 1-9, wherein the pre-processed task description further comprises one or more proposed supplemental resources for enhancing a quality of generated outputs associated with the received input.
Clause 11: A processing system, comprising means for performing a method in accordance with any one of Clauses 1-10.
Clause 12: A non-transitory computer-readable medium comprising computer-executable instructions that, when executed by one or more processors of a processing system, cause the processing system to perform a method in accordance with any one of Clauses 1-10.
Clause 13: A computer program product embodied on a computer-readable storage medium comprising code for performing a method in accordance with any one of Clauses 1-10.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for generating modified prompts, comprising:
receiving input comprising one of a target prompt or a preliminary task description from a user;
generating, using a context processing component, a first prompt by incorporating the input into a prompt template corresponding to an input type associated with the input, wherein the first prompt is configured to cause a language model to generate a pre-processed task description associated with the input;
providing the first prompt to a language model for generating the pre-processed task description associated with the input;
receiving the pre-processed task description from the language model;
generating a second prompt by incorporating the pre-processed task description and the input into a second prompt template, wherein the second prompt is configured to cause the language model to generate a modified prompt based on the pre-processed task description and the input;
providing the second prompt to the language model for generating the modified prompt;
receiving the modified prompt from the language model; and
returning the modified prompt to the user.

2. The method of claim 1 further comprising receiving, from the user, an expected output structure for the input.

3. The method of claim 2, wherein the first prompt is generated by further incorporating the expected output structure for the input.

4. The method of claim 1, wherein the pre-processed task description associated with the input comprises one or more of a description of an objective, a step for achieving the objective, and an expected outcome.

5. The method of claim 4, wherein the pre-processed task description associated with the input further comprises instructions for one or more anticipated challenges based on the one or more of the description of the objective, the step for achieving the objective, and the expected outcome.

6. The method of claim 1, wherein the first prompt further causes the language model to remove noise and ambiguous language from the input.

7. The method of claim 4, wherein the second prompt is generated further based on the one or more of the description of the objective, the step for achieving the objective, and the expected outcome from the pre-processed task description.

8. The method of claim 1, wherein the input is associated with a first compatibility score below for a language model type corresponding to the language model.

9. The method of claim 8, wherein the modified prompt is associated with a second compatibility score for the language model type corresponding to the language model, the second compatibility score being greater than the first compatibility score and above a predetermined compatibility threshold.

10. The method of claim 1, wherein the pre-processed task description further comprises one or more proposed supplemental resources for enhancing a quality of generated outputs associated with the received input.

11. A processing system, comprising:
one or more memories comprising computer-executable instructions; and
one or more processors configured to execute the computer-executable instructions causing the processing system to:
receive input comprising one of a target prompt or a preliminary task description from a user;
generate, using a context processing component, a first prompt by incorporating the input into a prompt template corresponding to an input type associated with the input, where the first prompt is configured to cause a language model to generate a pre-processed task description associated with the input;
provide the first prompt to a language model for generating the pre-processed task description associated with the input;
receive the pre-processed task description from the language model;
generate a second prompt by incorporating the pre-processed task description and the input into a second prompt template, wherein the second prompt is configured to cause the language model to generate a modified prompt based on the pre-processed task description and the input;
provide the second prompt to the language model for generating the modified prompt
receive the modified prompt from the language model; and
return the modified prompt to the user.

12. The processing system of claim 11, wherein the one or more processors are further configured to cause the processing system to receive, from the user, an expected output structure for the input.

13. The processing system of claim 12, wherein the first prompt is generated by further incorporating the expected output structure for the input.

14. The processing system of claim 11, wherein the pre-processed task description associated with the input comprises one or more of a description of an objective, a step for achieving the objective, and an expected outcome.

15. The processing system of claim 14, wherein the pre-processed task description associated with the input further comprises instructions for one or more anticipated challenges based on the one or more of the description of the objective, the step for achieving the objective, and the expected outcome.

16. The processing system of claim 11, wherein the first prompt further causes the language model to remove noise and ambiguous language from the input.

17. The processing system of claim 14, wherein the second prompt is generated further based on the one or more of the description of the objective, the step for achieving the objective, and the expected outcome from the pre-processed task description.

18. The processing system of claim 11, wherein the input is associated with a first compatibility score below for a language model type corresponding to the language model.

19. The processing system of claim 18, wherein the modified prompt is associated with a second compatibility score for the language model type corresponding to the language model, the second compatibility score being greater than the first compatibility score and above a predetermined compatibility threshold.

20. The processing system of claim 11, wherein the pre-processed task description further comprises one or more proposed supplemental resources for enhancing a quality of generated outputs associated with the received input.
